(19) United States
(12) Patent Application Publication
(10) Pub. No.: US 2009/0251422 A1
(43) Pub. Date: Oct. 8, 2009

(54) METHOD AND SYSTEM FOR ENHANCING INTERACTION OF A VIRTUAL KEYBOARD PROVIDED THROUGH A SMALL TOUCH SCREEN

(75) Inventors: Yingfei Wu, Beijing (CN); Rui Zhang, Beijing (CN); Tom Plocher, Hugo, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/099,366

(22) Filed: Apr. 8, 2008

(51) Int. Cl. G06F 3/041

(52) U.S. Cl. 345/173

(57) ABSTRACT

A method and system for enhancing interaction of a virtual keyboard in a small touch screen. The virtual keyboard includes multiple virtual keys and can be divided into more than one block. Proximity sensors associated with the touch screen can sense the 3D position of a physical selector (e.g., user's finger or stylus) before it contacts the touch screen. When the physical selector is close enough to the touch screen, a block of the virtual keyboard or group of characters nearest the physical selector can be enlarged for selection by physical contact of the physical selector with the touch screen. The virtual keyboard can also be enlarged according to the position of the physical selector in a continual manner, wherein the extent of the enlargement is proportional to the proximity of the physical selector to the screen. Further, a character immediately under the physical selector can also be enlarged in order to determine intent with high reliability.

### TECHNICAL FIELD

Embodiments are generally related to small touch screens. Embodiments are more particularly related to methods and systems for enhancing interaction of a virtual keyboard provided through a small touch screen.

### BACKGROUND OF THE INVENTION

Touch screens are known as a type of display screen, which can be provided with a touch-sensitive transparent panel covering the display screen. Touch screens, also commonly referred to as touch-sensitive display screens, are commonly utilized in portable devices, such as PDAs, mobile phones, but small touch screens are also finding their way into home products such as appliances, security panels, thermostats and various personal health monitoring devices. Touch screens are widely utilized as an interface for inputting data. The small touch screen typically includes a virtual keyboard that enables the entry of characters on the touch-sensitive screen, wherein a user can select virtual keys on the keyboard by directly touching them with a stylus or a user's finger tip.

The virtual keys in a majority of prior art virtual keyboards are typically smaller than the user's finger. Therefore, a finger can frequently touch the wrong key. Additionally, the virtual keys are sometimes not clear enough for some users to see in order to select them. Hence, a stylus can be utilized to enter characters through the virtual keyboard provided as part of a PDA in order to avoid the wrong selection of the virtual keys in the virtual keyboard. The stylus can become lost easily and is also not convenient to carry apart from a PDA. It is therefore desirable to increase usability of display screens for activating the virtual keys in a convenient manner and in order to enable the selection of correct keys in the virtual keyboard.

Referring to FIG. 1 a schematic view of a prior art handheld electronic device 100 with a touch-sensitive display screen 110 is illustrated. Examples of handheld electronic devices 100 include mobile phone or a personal digital assistant (PDA). The handheld electronic device 100 can include a touch screen 110 and an input control unit 120, which can be mounted within the handheld electronic device 100. The touch-sensitive display screen 110 can display a virtual keyboard 130 with virtual keys 140 and an input character display area 150.

The operator can select the virtual keys 140 by touching the virtual keyboard 130, and characters on the virtual keys 140 can be recognized based on a position touched by the operator. After recognizing the characters, the prior art system provides an enlarged image of the touched virtual key 140 for display on the input character display areas 150 of the touch-sensitive display screen 110. By using the enlarged image of the virtual key 140, the operator can select the character on the touch-sensitive display screen 110. The touch-sensitive display screen 110 can attempt to solve the problem of a user entering incorrect virtual keys where a user monitors what has already been entered, but this type of system requires several touching actions by the operator to erase a wrong and select the correct single character on the touch-sensitive display screen 110 as characters are entered.

Referring to FIG. 2 a schematic view of another prior art system 200 incorporating a touch-sensitive display 110 including a virtual ABCD format keyboard 130 with virtual keys 140 and an input character display area 150 is illustrated. In such a touch screen-based system 200, the user can select the virtual keys 140 by touching in the vicinity of the desired key on the virtual keyboard 130. Sensing location only by direct physical contact where the user has touched the screen, the system can then display virtual keys 140 in the vicinity of the location touched as possible candidates for selection. Only after physical contact with the screen can the system magnify virtual keys in the vicinity large enough to be accurately touched and selected. The user makes a second pointing and touching action on the magnified representation of the virtual keys and can more accurately select a desired key from the magnified subset of virtual 140 keys, accurate selection enabled because of the keys' larger size. The selected keys are then displayed in the input character display areas 150. This touch screen device also represents a system where at least two or more pointing and touching actions, i.e., “clicks”, by the user are required in order to enter a single character for display in the input character display area 150.

Other features found in the art enable a list of candidate words to be displayed in a candidate word display area 160. Candidate words can be displayed in order of likelihood and/or based on frequency of use. Such a feature enables the user to confirm a set of keys 140 by touching the desired candidate word in the displayed list. Accordingly, when the key is confirmed by physically touching the screen to select a word, an offset between the selected position and the position actually touched can be computed to re-calibrate for a next touching action such as system can provide a solution to wrong word selection in the display 110, but like all other prior art system, it requires multiple pointing and touching actions and an intermediate step for selecting a proper character and/or word from the candidate word list based on user selections on the touch-sensitive display 110.

Therefore, a need exists for improved methods and systems enhancing a user's interaction with virtual keyboards in small touch screens. What is needed is a system and methods that is more accurate and efficient in the selection of characters, specifically after single contact with a touch-sensitive display per character sought by a user (or as will also be commonly referred to herein “in just one click”). Such improved methods and systems are described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for improved methods and systems for enhancing interaction of a virtual keyboard in a small touch screen.

It is another aspect of the present invention to provide for improved methods and systems for selecting a character in a small touch screen correctly with just one physical contact (e.g., “click”) on the small touch screen by a user with a stylus or the user's finger.

The aforementioned aspects and other objectives and advantages can now be achieved as described herein. A method and system for enhancing interaction of a virtual keyboard in a small touch screen. The virtual keyboard includes multiple virtual keys and can be divided into sections. Proximity sensors included within or in addition to the touch screen can sense the 3D position of a user's stylus or finger (i.e., “physical selector”) before it contacts the touch screen. When the physical selector is close enough to proximity sensors in the touch screen, a section of the virtual keyboard nearest the physical selector can become active and enlarged for more specific key selection. The virtual keyboard can also be enlarged according to the position of the physical selector in a continual manner, wherein the extent of the enlargement is proportional to the proximity of the physical selector to the screen. Further, a character immediately under the physical selector can also be enlarged in order to determine intent with high reliability.

In accordance with another feature, proximity sensors can be provided in the form of capacitive sensors integrated within the display screen. Capacitive sensors can be made of any conductive material, but not limited to conductors, wire, tape or filaments and adapted to track the movement of any object or material at distances away from a touch screen with improved accuracy. Such capacitive sensors can convert a three-dimensional position of the object into a digital signal, which can allow a processor chip of any computer or electronic device to interpret inputs and direction of the user's physical selector. The capacitive sensors can optionally be provided and operated based on known Ether Touch™ technology, which is an advanced capacitive 3D sensing technology.

In the aforementioned embodiment, proximity sensor technology can be utilized to sense a 3D position of finger before it contacts the touch screen. The virtual keyboard can be clear enough to select key and enter a character correctly in just one physical selection (“click”) of an area of a touch screen. The method and system disclosed in greater detail herein enable an enhanced interaction of the virtual keyboard in the small touch screen in order to achieve easy operation and handling of handheld electronic devices.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic view of a prior art handheld electronic device with a conventional touch screen;

FIG. 2 illustrates a schematic view of another prior art touch screen of showing a virtual ABCD format keyboard;

FIG. 3 illustrates a pictorial representation of a virtual keyboard in a small touch screen of a display panel, which can be implemented in accordance with a preferred embodiment;

FIGS. 4-5 illustrate pictorial representations of different enlarged blocks of the virtual keyboard as shown in FIG. 3, which can be implemented in accordance with a preferred embodiment;

FIG. 6 illustrates an original view of a virtual keyboard in a small touch screen of a display panel, which can be implemented in accordance with an alternative embodiment;

FIGS. 7-8 illustrate pictorial representations of different enlargements of the virtual keyboard as shown in FIG. 6, which can be implemented in accordance with an alternative embodiment;

FIG. 9 illustrates an original view of a virtual keyboard in a small touch screen of a display panel, which can be implemented in accordance with an alternative embodiment;

FIG. 10 illustrates a display panel with a character box displayed in a separate area of the touch screen as shown in FIG. 9, which can be implemented in accordance with an alternative embodiment;

FIG. 11 illustrates a schematic view of a touch screen circuit interconnected with a computer module, which can be implemented in accordance with an alternative embodiment;

FIG. 12 illustrates a flowchart of a method for enhancing interaction of a virtual keyboard in a small touch screen, which can be implemented in accordance with a preferred embodiment;

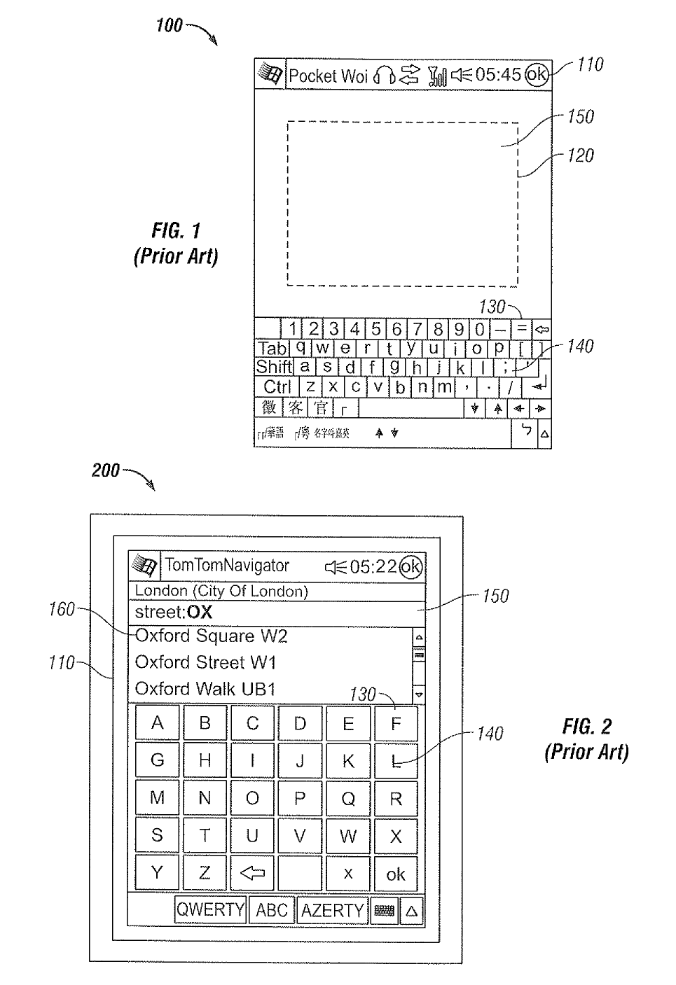

### DETAILED DESCRIPTION

The particular values and configurations discussed in these non-limiting examples can be varied and are cited merely to illustrate at least one embodiment and are not intended to limit the scope thereof.

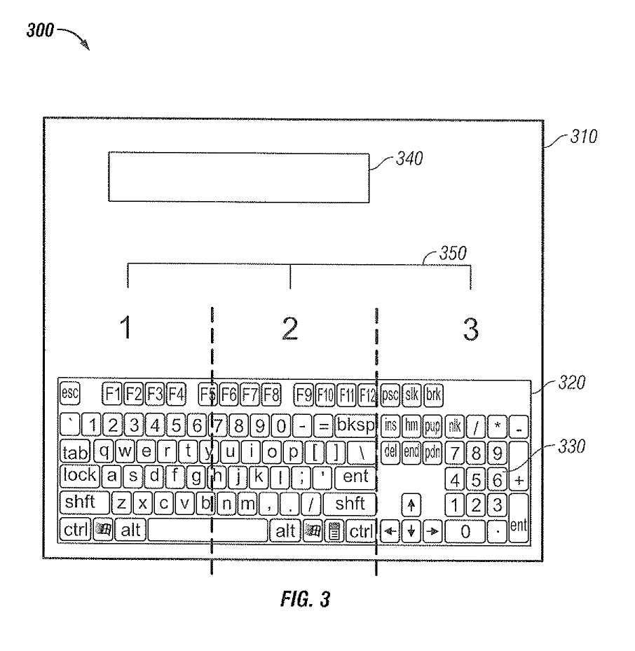

Referring to FIG. 3 a pictorial representation of a virtual keyboard 320 in a small touch screen 310 of a display panel 300 is illustrated, which can be implemented in accordance with a preferred embodiment. The display panel 300 with small touch screen 310 can be generally provided in mobile telephones (not shown) in order to interface inputs by directly touching icons displayed in the touch screen 310. In the preferred embodiment, the touch screen 310 can include a display screen 340 and a virtual keyboard 320. The display screen 340 can display characters selected by the user. In the virtual keyboard 320, virtual keys 330 can be arranged in a pre-determined space between them. Each virtual 330 can include individual representative position in the touch screen 310.

The virtual keyboard 320 can be divided into three or more blocks 350. When a physical selector (e.g., user's finger or stylus) is close enough to the touch screen 310, the block 350 nearest the physical selector can be selected and enlarged for specific key selection. A 3D position of the physical selector can be sensed before it can contact the touch screen 310 using proximity sensor integrated with the touch screen. Proximity sensors can be provided in the form of capacitive sensor, such as that provided by Ether Touch™ technology. A trajectory of the physical selector can also be tracked toward a point on the virtual keyboard 320 using the proximity sensors.

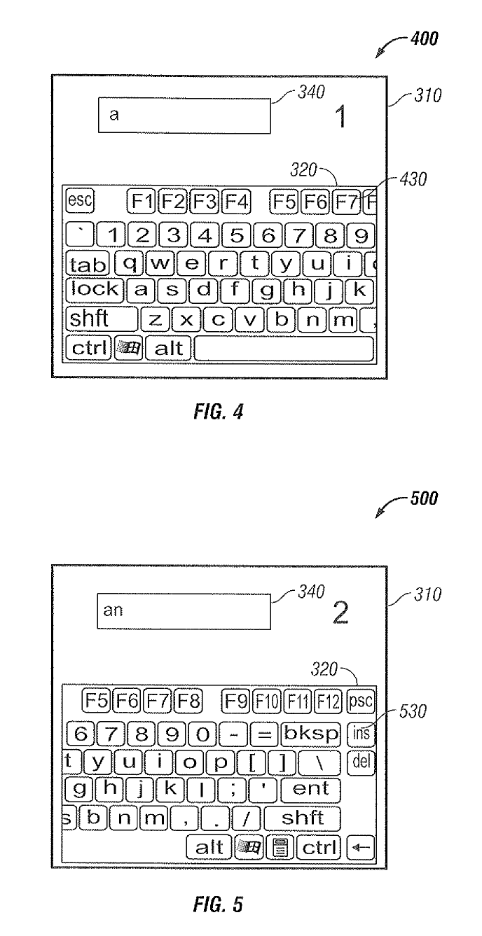

Referring to FIGS. 4-5 pictorial representations of different enlarged blocks 400/500 and of the virtual keyboard 310 as shown in FIG. 4 are illustrated, which can be implemented in accordance with a preferred embodiment. The enlarged blocks of the virtual keyboard 310 can include only a limited number of virtual keys 430/530 in accordance with the division of the virtual keyboard 310 such that the user can select a correct key when sections of the virtual keyboard 310 are enlarged. In order to ensure right selection, the enlarged block of the virtual keyboard 310 shown in FIGS. 4-5 can include more keys 430/530 than the divided block.

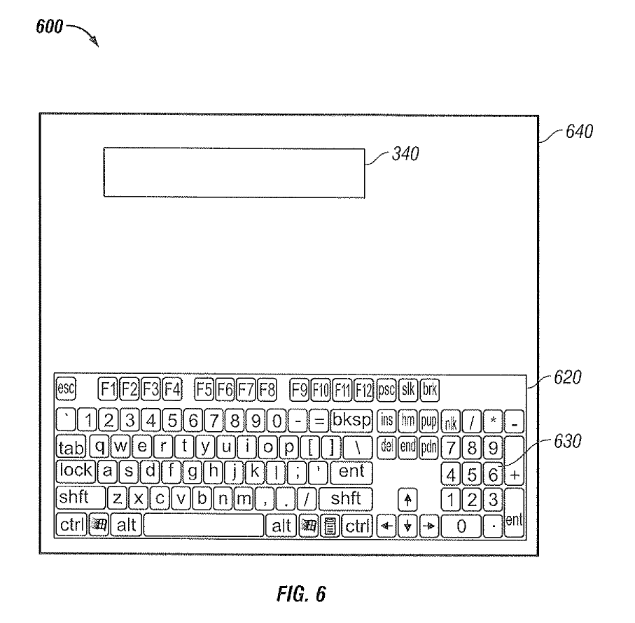

Referring to FIG. 6, an original view of a virtual keyboard 620 in a small touch screen 310 of a display panel 600 is illustrated, which can be implemented in accordance with an alternative embodiment. The virtual keyboard 620 can include multiple virtual keys 630, in particular numeric keys, i.e., 0-9, alphabet keys, functional keys, special keys or symbol keys. The virtual keyboard 620 can be displayed on the touch screen 310, more preferably in rectangular fashion. In this embodiment, the touch screen 310 can initially represent the virtual keyboard 620 in miniature-size and the display screen 640 in normal size. Thereafter, the virtual keyboard 620 can be enlarged according to a position of the physical selector in a continual manner. For example, when a user's finger or stylus approaches alphabet key “A” 630 of the virtual keyboard 620, that alphabet key “A” and adjacent keys of the virtual keyboard 620 can continually be enlarged while the user's finger/stylus is over the area represented by key “A” and adjacent keys. The extent of enlargement is proportional to proximity of the physical selector to the touch screen 310. When the physical selector is withdrawn from its close proximity (but not in contact) with the touch screen, the virtual keyboard 620 returns to its nominal size.

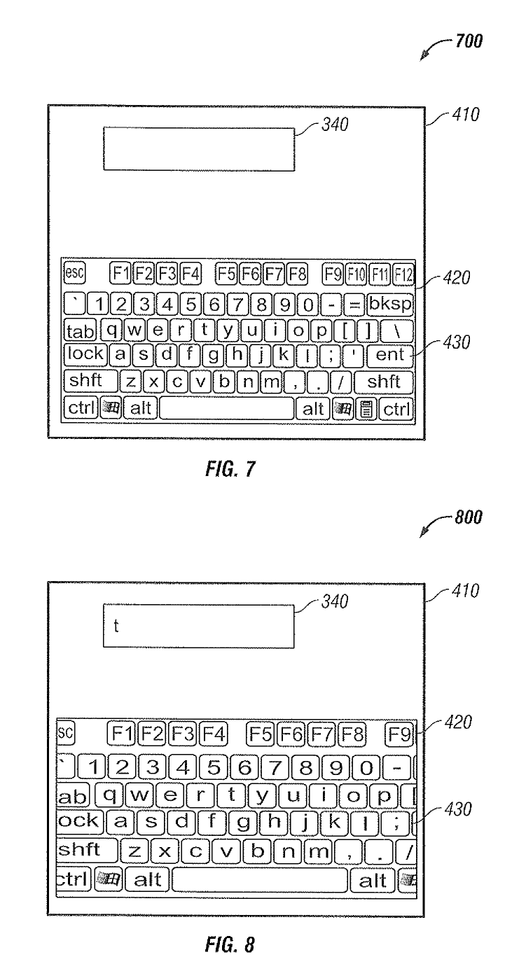

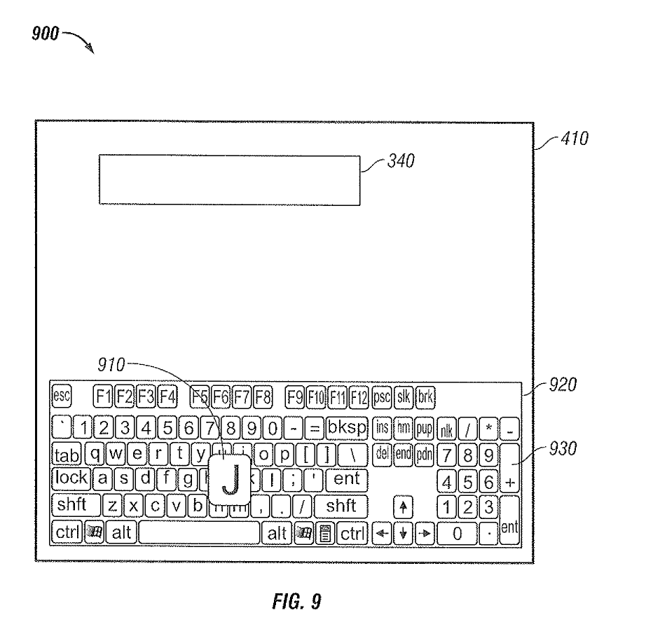

Referring to FIGS. 7-8 pictorial representations of different enlargements of the virtual keyboard 620 as shown in FIG. 6 are illustrated, and which can be implemented in accordance with an alternative embodiment. When the physical selector is placed near and over the touch screen 410, the portions of virtual keyboard 420 can be enlarged accordingly. In FIG. 7, the virtual keyboard 620 can be shown slightly larger because the physical selector is not very close to the touch screen 310. In FIG. 8, the virtual keyboard 620 can include a limited number of virtual keys 830 in an enlarged fashion because the physical selector is very close to the touch screen 410. Therefore, the virtual keys 430 of the virtual keyboard 420 can be sized to allow reliable location activation in order to enable the user to easily and reliably enter the characters through the touch screen 410.

Referring to FIG. 9 an original view of a virtual keyboard 920 in a small touch screen 310 of a display panel 900 is illustrated, which can be implemented in accordance with an alternative embodiment. The display panel 900 can incorporate the small touch screen 310 with a virtual keyboard 920. The virtual keyboard 920 can include multiple virtual keys 930 with characters associated with them. Given proximity sensing technology incorporated within or with the aforementioned touch screen 310, the area and/or character immediately under the physical selector will only be enlarged and a character (e.g., virtual key) can then be physically selected by direct contact of the physical selector with the surface of the touch screen.

The selected and enlarged characters can be displayed in a separate character box 910. The physical selector can be placed close enough to the touch screen 310 in order to determine user intent with high reliability. A separate character box 910 can be designed to be large enough to reliably select the character using a physical selector. It should be noted that the virtual keyboard 920 actually viewable by the user might not directly coincide with irregularly shaped boundaries of the virtual keys 930.

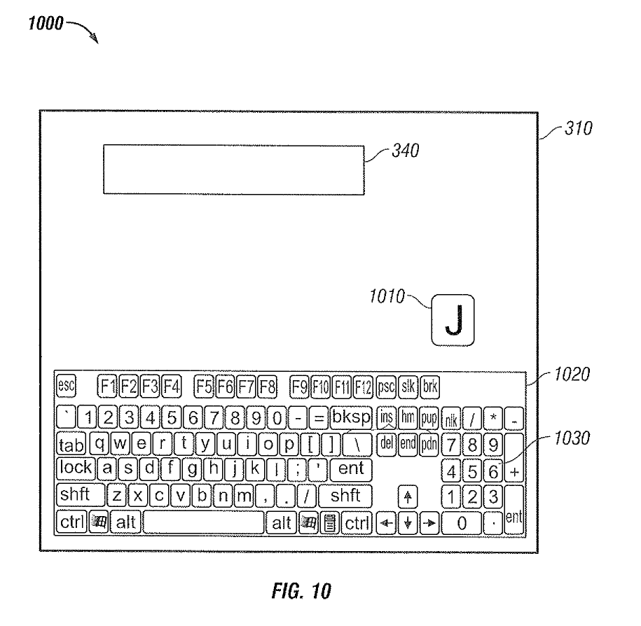

Referring to FIG. 10 a display panel 1000 with a character box 1010 displayed in a separate area 1010 of the touch screen 310 as shown, which can be implemented in accordance with an alternative embodiment. An enlarged character (example “J”) in the character box 1010 can be displayed in a separate area of the touch screen 310. Thus, the user can select another virtual key 1030 adjacent to the previously selected key 1030 without any disturbances. Additionally, the touch screen 310 in current form can provide feedback to the user about the accuracy of key selection in an assistance manner.

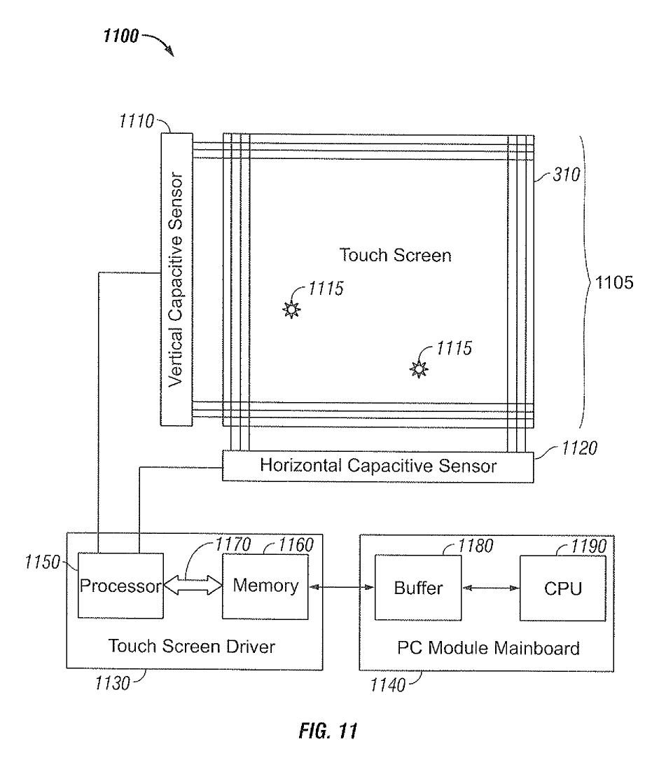

Referring to FIG. 11 a schematic view of a touch screen circuit 1100 interconnected with a computer module 1140 is illustrated, which can be implemented in accordance with an alternative embodiment. The touch screen circuit 1105 can include a touch screen 310, vertical capacitive sensor array circuit 1110, and horizontal capacitive sensor array circuit 1120 and touch screen driver 1130. The aforementioned components of the touch screen circuit 1100 can be electrically interconnected with each other. The touch screen 310 can be adapted for displaying image icons and for touching to control an operation of a handheld electronic device (not shown), e.g., mobile phone, personal digital assistant (PDA), personal computer, laptop, etc. The vertical and horizontal capacitive sensors 1115 can be arrayed around the touch screen 310 and can provide a simple and inexpensive hardware basis for sensing a position of a user's physical selector in cooperation with supporting vertical capacitive sensor array circuit 1110, and horizontal capacitive sensor array circuit 1120 based on activation of capacitive sensors 1115 with a physical selector.

In accordance with another feature, the capacitive touch screen 310 can be coated with a material, e.g., indium tin oxide, that can conduct a continuous electrical current across the screen area monitored by sensors under the control of the vertical and horizontal capacitive arrays, 1110/1120. Therefore, the sensors 1110 and 1120 can exhibit a precisely controlled field of stored electrons in both the horizontal and vertical axes. When the sensor's capacitance field is altered by another capacitance field, i.e., someone's finger in contract with a screen, electronic circuits (not shown) located at each corner of the touch screen 310 can send information about an event to a processor 1150 in the touch screen driver 1130 for mathematical processing. The touch screen driver 1130 can be electrically coupled to a PC module main board 1140 with CPU 1190.

The processor 1150 of the touch screen driver 1130 can convert the information into digital data by accessing pre-determined information stored in a memory 1160 via a data bus 1170. The converted digital data can further be processed in the CPU 1190 in the main board 1140 via a buffer 1180. Finally, the CPU 1190 can facilitate an enlarging function of the representative virtual keys 1030 of the virtual keyboard 1020, as shown in FIG. 10.

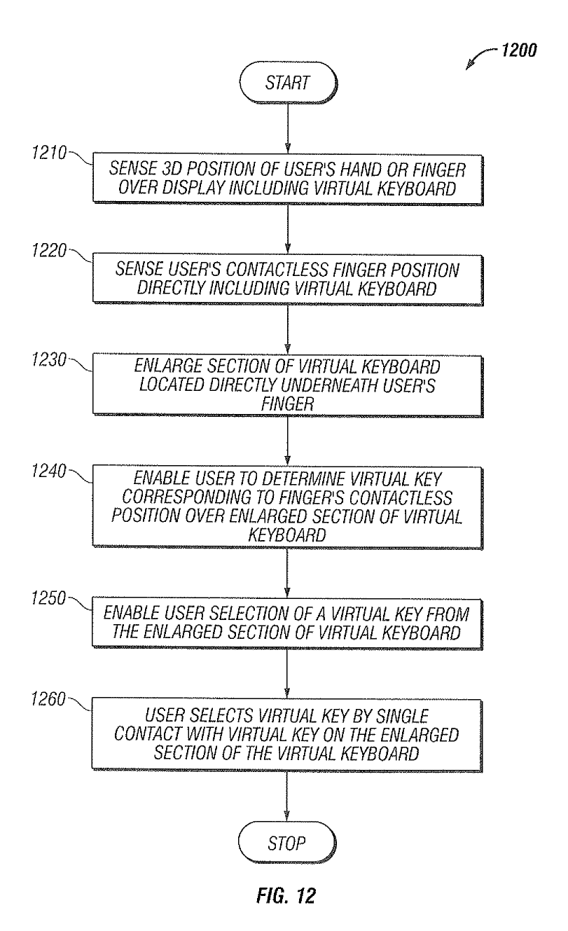

Referring to FIG. 12 a flowchart 1200 of a method for enhancing interaction of a virtual keyboard in a small touch screen is illustrated, which can be implemented in accordance with a preferred embodiment. The method can enhance interaction of the small touch screen by dividing unique interaction with the virtual keyboard into three or more blocks. As illustrated at block 1210, a 3D position of a physical selector can be sensed over the display including the virtual keyboard. Position is sensed without contact being made with the touch screen 410, using the proximity sensors described herein (and which can be based on the use of Ether Touch™ technology). As indicated in block 1220, the user's contactless physical selector position can be sensed directly over a section of (near a point on) the virtual keyboard 420.

Furthermore, as specified at block 1230, a section of virtual keyboard (e.g., the virtual key) located directly underneath a user's physical selector is enlarged. A group of keys corresponding to the position of the physical selector over the virtual keyboard can be enlarged as the section of the virtual keyboard when physical selector position is determined. As illustrated at block 1240, a user is enabled to determine a virtual key corresponding to the user's contactless physical selector position over the enlarged section of virtual keyboard. Afterwards, one of the blocks of the virtual keyboard can be selected based on physical contact of the physical selector with a desired virtual key from the enlarged section of virtual keyboard, as depicted at block 1250. The selected area of the virtual keyboard can be enlarged such that the virtual keyboard can be clear enough to select key and to enter the character correctly “in just one click”. Finally, as depicted in block 1260 the user selects a virtual key by a single contact with the virtual key on the enlarged section of virtual keyboard. Thus, the present invention can enable an easier and convenient use of a touch screen enabled device in any mode of operations.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for enhancing interaction of a virtual keyboard associated with a small touch-sensitive display screen, said method comprising:
providing a virtual keyboard represented in a touch-sensitive display screen of at least one block, wherein said virtual keyboard includes a plurality of virtual keys associated with an individual representative position in said touch-sensitive display screen;
sensing a three-dimensional position of a physical selector over said touch-sensitive display screen utilizing a plurality of proximity sensors associated with said touch-sensitive display screen before said physical selector contacts said touch-sensitive display screen; and
enlarging at least one of said virtual keys and said at least one block of said virtual keyboard when the physical selector is close to said touch screen without making contact.

2. The method of claim 1 further comprising:
enlarging said virtual keyboard in accordance with the three-dimensional position of the physical selector in a continual manner, wherein the extent of the enlargement is proportional to the proximity of the physical selector to said touch-sensitive display screen.

3. The method of claim 1 further comprising:
enlarging a character associated with one of said plurality of virtual keys immediately under the physical selector, while the physical selector is close to said touch screen without making contact with it.

4. The method of claim 1, wherein said proximity sensors further comprise a plurality of capacitive sensors adapted to enable sensing of the physical selector's location about said touch-sensitive display screen wherein the physical selector's location is determined by said plurality of capacitive sensors.

5. The method of claim 1 wherein said small touch-sensitive display screen is utilized on electronic devices including at least one of: a personal digital assistant, a mobile phone, a thermostat, an appliance, a medical device, a display.

6. The method of claim 1 further comprising the step of tracking trajectory of the physical selector toward a point on said virtual keyboard prior to physical selection of an enlarged of at least one of said virtual keys and said at least one block of said virtual keyboard when the physical selector is in close to said touch screen without making contact.

7. A touch-sensitive display system, comprising:
a plurality of proximity sensors integrated with and throughout a touch-sensitive display screen and adapted to sense a user's finger in close proximity with portions of said touch-sensitive display screen; and
a program module adapted to enable an area of a virtual keyboard displayed on said touch-sensitive display screen and virtual keys associated therewith to become enlarged when a physical selector is sensed in close proximity to proximity sensors assigned within the area of said touch-sensitive display screen.

8. The system of claim 7 wherein said plurality of proximity sensor are provided as capacitive sensors arrayed around said small touch-sensitive display screen.

9. The system of claim 7 wherein said small touch screen is coated with a material, in particular indium tin oxide that conducts a continuous electrical current across said plurality of proximity sensors.

10. The system of claim 7 wherein said plurality of proximity sensors further comprises capacitive sensor connected to at least one vertical capacitive sensor array and at least one horizontal capacitive sensor array.

11. The system of claim 7 further comprising a personal digital assistant, wherein said small touch-sensitive display screen is included on said personal digital assistant.

12. The system of claim 7 further comprising a mobile phone, wherein said small touch-sensitive display screen is included on said mobile phone.

13. The system of claim 7 further comprising a thermostat, wherein said small touch-sensitive display screen is included on said thermostat,

14. The system of claim 7 further comprising an appliance, wherein said small touch-sensitive display screen is included on said appliance.

15. The system of claim 7 further comprising an automotive display, wherein said small touch-sensitive display screen is included on said automotive display.

16. The system of claim 7 further comprising a medical device, wherein said small touch-sensitive display screen is included on said medical device.

17. A method for enhancing interaction of a virtual keyboard associated with a small touch-sensitive display screen, said method comprising:
providing a virtual keyboard represented in a touch-sensitive display screen having a surface and including a plurality of proximity sensors co-located throughout said touch-sensitive display screen, wherein said virtual keyboard includes a plurality of virtual keys;
sensing a three-dimensional position of a physical selector over said touch-sensitive display screen with said proximity sensor before said physical selector contacts the surface of said touch-sensitive display screen; and
enlarging at least one of said virtual keys of said virtual keyboard when the physical selector is in close proximity to the surface of said touch screen without making physical contact with the surface.

18. The method of claim 17 further comprising providing a plurality of capacitive sensors as said proximity sensors, said capacitive sensor adapted to sense the physical selector in close proximity to the surface of said touch-sensitive display screen.

19. The method of claim 17 further comprising providing a program module adapted to enable an area of a virtual keyboard displayed on said touch-sensitive display screen and virtual keys associated therewith to become enlarged when a physical selector is in close proximity the surface of said touch-sensitive display screen and to proximity sensors associated with said touch-sensitive display screen wherein the physical selector is sensed.

20. The method of claim 18 further comprising providing a program module adapted to enable an area of a virtual keyboard displayed on said touch-sensitive display screen and virtual keys associated therewith to become enlarged when a physical selector is in close proximity to proximity sensors associated with an area of said touch-sensitive display screen where the physical selector is sensed without touching the surface of said touch-sensitive display screen.
